(19) United States
(12) Patent Application Publication
(10) Pub. No.: US 2003/0043608 A1
(43) Pub. Date: Mar. 6, 2003

(54) Power circuit in uninterruptible power supply

(76) Inventor: Tien-Fu Huang, Tainan (TW)

Correspondence Address: MICHAEL BEST & FRIEDRICH LLC, 401 NORTH MICHIGAN AVENUE, SUITE 1700, CHICAGO, IL, 60611-4212, US

(21) Appl. No.: 10/200,698

(22) Filed: Jul. 22, 2002

(30) Foreign Application Priority Data
Aug. 28, 2001 (TW) 90214733

(51) Int. Cl. H02M 7/68

(52) U.S. Cl. 363/89

(57) ABSTRACT

A power circuit in an uninterruptible power supply system is provided. The power circuit arranged in an uninterruptible power supply system has a charging circuit for providing a stable voltage to charge an energy storage device, an energy recovery circuit for causing one winding of a transformer short-circuited to release an energy storage in the transformer of the power circuit, and an output voltage feedback control circuit for obtaining a voltage proportional to an output voltage by a coupling effect of the transformer during a discharging process.

### FIELD OF THE INVENTION

The present invention relates to a power circuit, and especially to a power circuit arranged in an uninterruptible power supply.

### BACKGROUND OF THE INVENTION

FIG. 1 shows an off-line uninterruptible power supply according to the prior art. Please refer to FIG. 1. A typical off-line uninterruptible power supply (UPS) includes a transformer 1, switches 2, a rectifier 3, an inverter 4, a controller 5, and a battery 6. When an AC input voltage vₛ is operated under normal condition, the switch 2 is turned on and the transformer 1 provides an output voltage Vₒᵤₜ to a load. At the same time, the output voltage Vₒᵤₜ is rectified by the rectifier 3 in order to charge the battery 6. When the AC input voltage Vₛ, is interrupted, the switches 2 are turned off and the controller 5 controls the inverter 4 to transform an electrical energy of the battery 6 to the output voltage Vₒᵤₜ through the transformer 1.

Generally speaking, an output voltage waveform of the off-line uninterruptible power supply probably is a square wave or a sine wave when the off-line uninterruptible power supply is under the discharging mode. The former is frequently used nowadays.

However, the off-line uninterruptible power supply has the following problems that should be dealt with:

(1) The off-line UPS needs a rectifier to convert the AC supply Vₛ to provide a stable output voltage even though the AC supply voltage Vₛ is varied.

(2) Another main issue is to continuously and stably charge the battery in the off-line UPS when the AC supply voltage Vₛ is operated under normal condition.

(3) The other main issue is to stabilize the output voltage and adjust the output waveform of the off-line uninterruptible power supply during the discharging process, when the AC supply voltage Vₛ is interrupted.

It is therefore attempted by the applicant to deal with the above situation encountered with the prior art and practically achieve the above functional requirements.

### SUMMARY OF THE INVENTION

The object of the present invention is to solve the problem or charging a battery under normal operation.

Another object of the present invention is to obtain the optimum design of the output waveform adjustment of the off-line uninterruptible power supply.

The other object of the present invention is to solve the problem of stabilizing the output voltage during the discharging process.

It is therefore an aspect of the present invention to propose a power circuit arranged in an uninterruptible power supply system that has a charging circuit for providing a stable voltage to charge an energy storage device, an energy recovery circuit for causing one winding of a transformer short-circuited to release an energy storage in the transformer of the power circuit, and an output voltage feedback control circuit for obtaining a voltage proportional to an output voltage by coupling effect of the transformer during a discharging process.

It is therefore another aspect of the present invention to propose a power circuit arranged in an uninterruptible power supply system that has an energy recovery circuit, which includes a half-bridge rectifier and a second switch for releasing an electrical energy stored in the transformer through the half-bridge rectifier.

According to an aspect of the present invention, the power circuit in an uninterruptible power supply system having a charging circuit includes a transformer having a primary winding electrically connected to a power source, and a secondary winding for providing a voltage, a half-bridge rectifier electrically connected to the secondary winding for rectifying the voltage to generate a first voltage, a filter electrically connected to the half-bridge rectifier for filtering the first voltage to generate a second voltage, an automatic voltage regulator electrically connected to the filter for regulating the second voltage to generate a stable third voltage, and an energy storage device electrically connected to the automatic voltage regulator for being charged by the third voltage.

Preferably, the power source is an AC power.

Preferably, the half-bridge rectifier includes a first diode having an anode end electrically connected to one end of the secondary winding, and a second diode having an anode end electrically connected to the other end of the secondary winding, and a cathode end electrically connected to a cathode end of the first diode for forming an output end of the half-bridge rectifier.

Preferably, the charging circuit further includes a current limiting device electrically connected to the output end of the half-bridge rectifier and an input end of the automatic voltage regulator for limiting a maximum charging current, which passes through the charging circuit.

Preferably, the current limiting device is an inductor.

Preferably, the automatic voltage regulator further includes a first switch electrically connected to a common ground (COM) of the automatic voltage regulator for controlling the power source to charge the energy storage device when the first switch is turned off.

Preferably, the first switch is a transistor switch.

Preferably, the power circuit further includes a third diode having an anode end electrically connected to an output end of the automatic voltage regulator, and a cathode end electrically connected to an input end of the automatic voltage regulator for providing a discharging passageway for sending back an over-charging energy of the energy storage device to the input end of the automatic voltage regulator.

Preferably, the automatic voltage regulator is a regulator transistor.

Preferably, the energy storage device is a battery.

Preferably, the filter is a capacitor.

Preferably, the power circuit further includes an output voltage feedback control circuit electrically connected to an input end of the automatic voltage regulator for obtaining an output voltage proportional to the voltage by coupling effect of the transformer during a discharging process.

Preferably, the output voltage feedback control circuit includes a first resistor having one end electrically connected to the input end of the automatic voltage regulator, and a second resistor having one end electrically connected to the other end of the first resistor for forming a node which is an output voltage feedback control end, and the other end electrically connected to ground.

Preferably, the power circuit further includes an energy recovery circuit for causing one winding of the transformer short-circuited to release an energy storage in the transformer.

Preferably, the energy recovery circuit includes the first diode, the second diode, and a second switch having a first conduction electrode electrically connected to the output end of the half-bridge rectifier, and a second conduction electrode electrically connected to a neutral line of the transformer for releasing an electrical energy stored in the transformer through the half-bridge rectifier when the second switch is turned on.

Preferably, the second switch is a transistor switch.

The present invention may best be understood through the following description with reference to the accompanying drawings, in which:

### BRIEF DESCRIPTION OF THE DRAWINGS

FIG. 1 illustrates an off-line uninterruptible power supply according to the prior art;

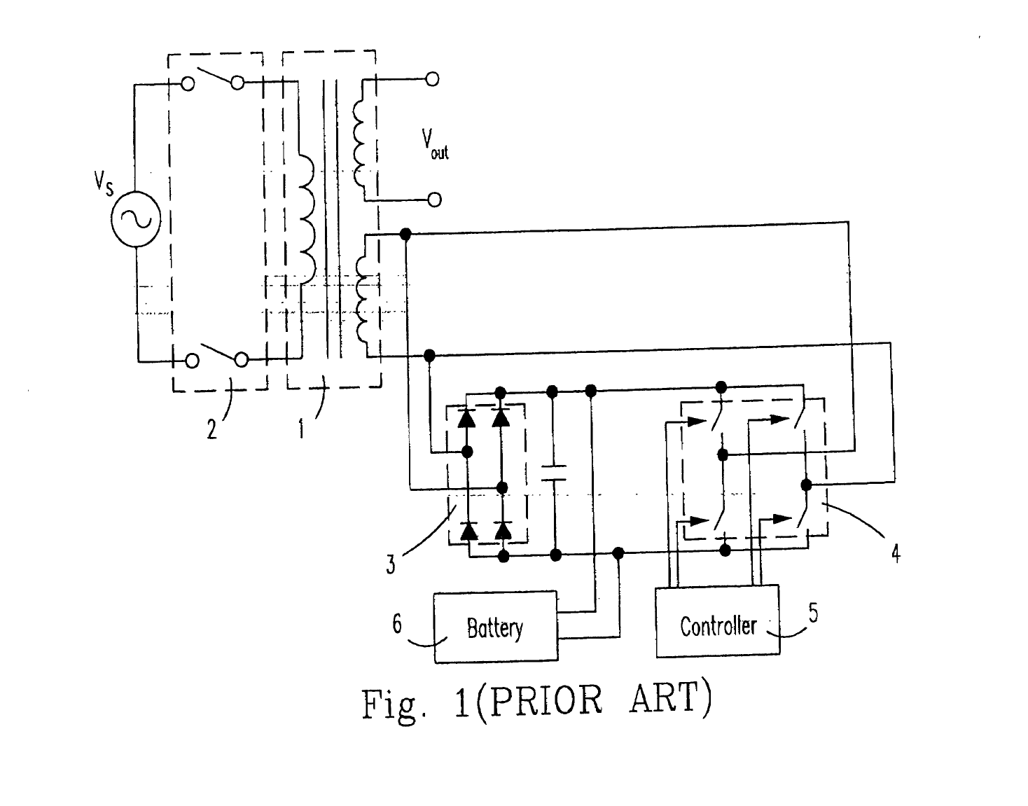

FIG. 2 is a block diagram partially illustrating a power circuit arranged in an uninterruptible power supply system according to a preferred embodiment of the present invention; and

FIG. 3 is a schematic diagram partially illustrating a power circuit arranged in an uninterruptible power supply system according to a preferred embodiment of the present invention.

### DETAILED DESCRIPTION OF THE PREFERRED EMBODIMENT

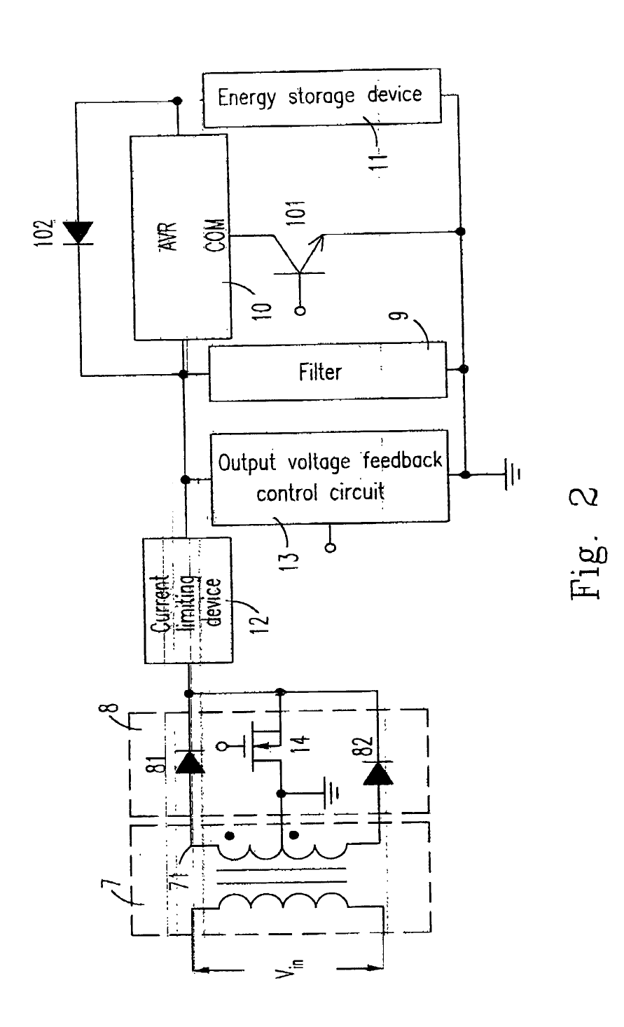

FIG. 2 is a block diagram partially illustrating a power circuit arranged in an uninterruptible power supply system according to a preferred embodiment of the present invention. As show in FIG. 2, the power circuit arranged in an uninterruptible power supply system has a charging circuit including a transformer 7, a half-bridge rectifier 8, a filter 9, an automatic voltage regulator (AVR) 10, an energy storage device 11, and a current limiting device 12. The transformer 7 has a primary winding electrically connected to a power source Vᵢₙ, and a secondary winding 71 for providing a voltage. The half-bridge rectifier 8 is electrically connected to the secondary winding 71 for rectifying the voltage to generate a first voltage. The current limiting device 12 is electrically connected to the output end of the half-bridge rectifier 8 and an input end of the automatic voltage regulator 10 for limiting a maximum charging current, which passes through the charging circuit. The filter 9 is electrically connected to the current limiting device 12 for filtering the first voltage to generate a second voltage. The automatic voltage regulator 10 is electrically connected to the filter 9 for regulating the second voltage to generate a stable third voltage. And, the energy storage device 11 is electrically connected to the automatic voltage regulator 10 for being charged by the third voltage.

Meanwhile, the power source Vᵢₙ is an AC power. The half-bridge rectifier 8 includes a first diode 81 and a second diode 82. The first diode 81 has an anode end electrically connected to one end of the secondary winding 71. The second diode 82 has an anode end electrically connected to the other end of the secondary winding 71, and a cathode end electrically connected to a cathode end of the first diode 81 for forming an output end of the half-bridge, rectifier 8.

Moreover, the automatic voltage regulator 10 further includes a first switch 101 electrically connected to a common ground (COM) of the automatic voltage regulator 10 for controlling the third voltage to charge the energy storage device 11 when the first switch 101 is turned off. The power circuit further includes a third diode 102 having an anode end electrically connected to an output end of the automatic voltage regulator 10, and a cathode end electrically connected to an input end of the automatic voltage regulator 10 for providing a discharging passageway for sending back an over-charging energy of the energy storage device 11 to the input end of the automatic voltage regulator 10.

Furthermore, the power circuit further includes an output voltage feedback control circuit 13 electrically connected to an input end of the automatic voltage regulator 10 for obtaining an output voltage proportional to the voltage by coupling effect of the transformer 7 during a discharging process.

On the other hand, the power circuit further includes an energy recovery circuit for causing one winding of the transformer 7 short-circuited to release an energy storage in the transformer 7. The energy recovery circuit includes the first diode 81, the second diode 82, and a second switch 14 having a first conduction electrode electrically connected to the output end of the half-bridge rectifier 8, and a second conduction electrode electrically connected to a neutral line of the transformer 7 for releasing an electrical energy stored in the transformer 7 through the half-bridge rectifier 8 when the second switch 14 is turned on.

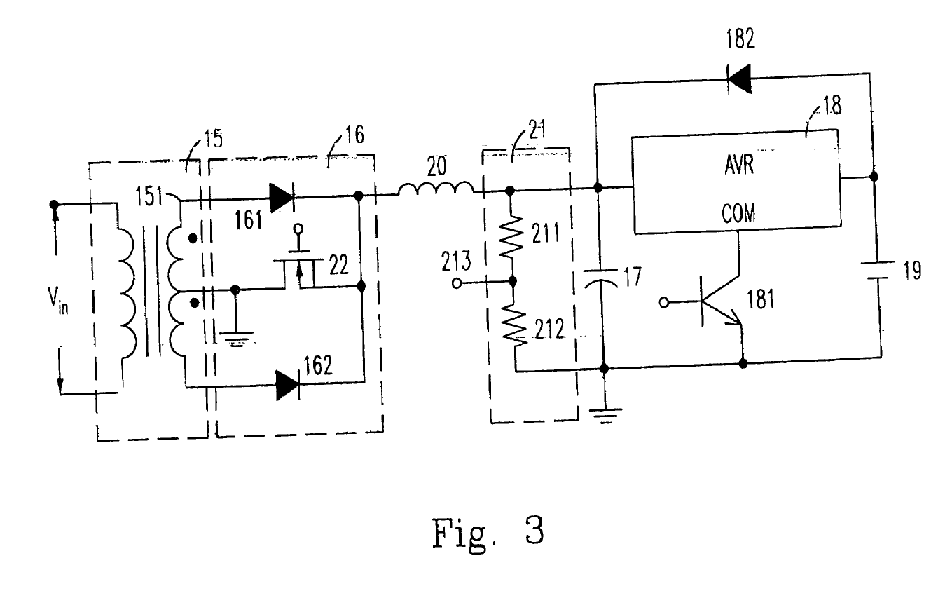

FIG. 3 is a schematic diagram partially illustrating a power circuit arranged in an uninterruptible power supply system according to a preferred embodiment of the present invention. As shown in FIG. 3, the power circuit arranged in an uninterruptible power supply system has a charging circuit including a transformer 15, a half-bridge rectifier 16, a filter capacitor 17, an automatic voltage regulator (AVR) 18, a battery 19 and an inductor 20. The transformer 15 has a primary winding electrically connected to a power source Vᵢₙ, and a secondary winding 151 for providing a voltage. The half-bridge rectifier 16 is electrically connected to the secondary winding 151 for rectifying the voltage to generate a first voltage. The half -bridge rectifier 16 includes a first diode 161, and a second diode 162. The first diode 161 has an anode end electrically connected to one end of the secondary winding 161. The second diode 162 has an anode end electrically connected to the other end of the secondary winding 151, and a cathode end electrically connected to a cathode end of the first diode 161 for forming an output end of the half-bridge rectifier 16. The inductor 20 is electrically connected to the output end of the half-bridge rectifier 16 and an input end of the automatic voltage regulator 18 for limiting a maximum charging current, which passes through the charging circuit. The filter capacitor 17 is electrically connected to the inductor 20 for filtering the first voltage to generate a second voltage. The automatic voltage regulator 18 is electrically connected to the filter capacitor 17 for regulating the second voltage to generate a stable third voltage. And, the battery 19 is electrically connected to the automatic voltage regulator 18 for being charged by the third voltage.

Meanwhile, the automatic voltage regulator 18 further includes a first switch 181 electrically connected to a common ground (COM) of the automatic voltage regulator 18 for controlling the third voltage to charge the battery 19 when the first switch 101 is turned off and not to charge the battery 19 when the first switch 101 is turned on.

However, the power circuit further includes a third diode 182 having an anode end electrically connected to an output end of the automatic voltage regulator 18, and a cathode end electrically connected to an input end of the automatic voltage regulator 18 for providing a discharging passageway for sending back an over-charging energy of the battery 19 to the input end of the automatic voltage regulator 18.

Moreover, the power circuit further includes an output voltage feedback control circuit 21 electrically connected to an input end of the automatic voltage regulator 18 for obtaining an output voltage proportional to the voltage by coupling effect of the transformer 15 during a discharging process. The output voltage feedback control circuit 21 includes a first resistor 211 and a second resistor 212. The first resistor 211 has one end electrically connected to the input end of the automatic voltage regulators 18. And, the second resistor 212 has one end electrically connected to the other end of the first resistor 211 for forming a node which is an output voltage feedback control end, and the other end electrically connected to ground. The power circuit further includes an energy recovery circuit for causing one winding of the transformer 15 short-circuited to release an energy storage in the transformer 15. The energy recovery circuit includes the first diode 161, the diode 162, and a second switch 22 having a first conduction electrode electrically connected to the output end of the half-bridge rectifier 16, and a second conduction electrode electrically connected to a neutral line of the transformer 15 for releasing an electrical energy stored in the transformer 15 through the half-bridge rectifier 16 when the second switch 22 is turned on.

According to the above descriptions, the present invention proposes a power circuit arranged in an uninterruptible power supply system has the charging circuit, the energy recovery circuit, and the output feedback control circuit. The present invention using a half-bridge rectifier instead of a full-bridge rectifier has the following advantages:

(1) Just need two diodes to rectifying the voltage.

(2) Decrease the energy barrier of the diodes. There exists two diode voltage drops when the electrical energy stored in the transformer is released through the full-bridge rectifier. This will affect the magnitude of the energy barrier and the total performance of the waveform adjustment. However The present invention uses a half-bridge rectifier instead of a full-bridge rectifier, therefore there exists only one diode voltage drop when the electrical energy stored in the transformer is released through the half-bridge rectifier. It can reduce the diode voltage drop and the bad effect of the total performance of the output waveform. Accordingly, the present invention can reduce the usage of the total amount of the diodes. Consequently, the cost can be reduced and the performance of output waveform will be better.

While the invention has been described in terms of what are presently considered to be the most practical and preferred embodiments, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A power circuit in an uninterruptible power supply system having a charging circuit, comprising:
a transformer having a primary winding electrically connected to a power source, and a secondary winding for providing a voltage;
a half-bridge rectifier electrically connected to said secondary winding for rectifying said voltage to generate a first voltage;
a filter electrically connected to said half-bridge rectifier for filtering said first voltage to generate a second voltage;
an automatic voltage regulator electrically connected to said filter for regulating said second voltage to generate a stable third voltage; and
an energy storage device electrically connected to said automatic voltage regulator for being charged by said third voltage.

2. The power circuit according to claim 1, wherein said power source is an AC power.

3. The power circuit according to claim 1, wherein said half-bridge rectifier comprises:
a first diode having an anode end electrically connected to one end of said secondary winding; and
a second diode having an anode end electrically connected to the other end of said secondary winding, and a cathode end electrically connected to a cathode end of said first diode for forming an output end of said half-bridge rectifier.

4. The power circuit according to claim 1, wherein said charging circuit further comprises a current limiting device electrically connected to said output end of said half-bridge rectifier and an input end of said automatic voltage regulator for limiting a maximum charging current which passes through said charging circuit.

5. The power circuit according to claim 4, wherein said current limiting device is an inductor.

6. The power circuit according to claim 1, wherein said automatic voltage regulator further comprises a first switch electrically connected to a common ground (COM) of said automatic voltage regulator for controlling said power source to charge said energy storage device when said first switch is turned off.

7. The power circuit according to claim 6, wherein said first switch is a transistor switch.

8. The power circuit according to claim 1, wherein said power circuit further comprises a third diode having an anode end electrically connected to an output end of said automatic voltage regulator, and a cathode end electrically connected to an input end of said automatic voltage regulator for providing a discharging passageway for sending back an over-charging energy of said energy storage device to said input end of said automatic voltage regulator.

9. The power circuit according to claim 1, wherein said automatic voltage regulator is a regulator transistor.

10. The power circuit according to claim 1, wherein said energy storage device is a battery.

11. The power circuit according to claim 1, wherein said filter is a capacitor.

12. The power circuit according to claim 1, wherein said power circuit further comprises an output voltage feedback control circuit electrically connected to an input end of said automatic voltage regulator for obtaining an output voltage proportional to said voltage by a coupling effect of said transformer during a discharging process.

13. The power circuit according to claim 12, wherein said output voltage feedback control circuit comprises:
a first resistor having one end electrically connected to said input end of said automatic voltage regulator; and
a second resistor having one end electrically connected to the other end of said first resistor for forming a node, which is an output voltage feedback control end, and the other end electrically connected to ground.

14. The power circuit according to claim 1, wherein said power circuit further comprises an energy recovery circuit for causing one winding of said transformer short-circuited to release an energy storage in said transformer.

15. The power circuit according to claim 14, wherein said energy recovery circuit comprises said first diode, said second diode, and a second switch having a first conduction electrode electrically connected to said output end of said half-bridge rectifier, and a second conduction electrode electrically connected to a neutral line of said transformer for releasing an electrical energy stored in said transformer through said half-bridge rectifier when said second switch is turned on.

16. The power circuit according to claim 15, wherein said second switch is a transistor switch.
